(19) United States
(12) Patent Application Publication
(10) Pub. No.: US 2011/0093274 A1
(43) Pub. Date: Apr. 21, 2011

(54) APPARATUS AND METHOD OF MANUFACTURING ARTICLE USING SOUND

(76) Inventor: Kwanyoung Lee, Gyeonggi-do (KR)

(21) Appl. No.: 12/866,553

(22) PCT Filed: May 16, 2008
(86) PCT No.: PCT/KR2008/002764

§ 371 Date: Aug. 6, 2010

(30) Foreign Application Priority Data
Feb. 12, 2008 (KR) 10-2008-0012557
Mar. 28, 2008 (KR) 10-2008-0028755

(51) Int. Cl. G10L 21/06

(52) U.S. Cl. 704/276; 704/E21.019

(57) ABSTRACT

Disclosed is an apparatus and method of manufacturing an article using sound that modifies sound waveforms for sound of living things (including human voice) in various shapes and manufactures articles corresponding to the shapes. An apparatus for manufacturing an article using sound generates a sampling waveform based on the sound waveform. Next, the sampling waveform is converted into a two-dimensional image file and the two-dimensional image is again converted into a three-dimensional image file. Thereafter, an article is manufactured based on the two-dimensional or three-dimensional image file. According to the invention, the apparatus and method of manufacturing an article using sound manufactures an article based on the sampling waveform generated by sampling the sound waveform, thereby manufacturing a simplified article.

### TECHNICAL FIELD

The present invention relates to an apparatus and method of manufacturing an article using sound, and in particular, to an apparatus and method that can manufacture articles using the sound of living things, including human voice.

### BACKGROUND ART

The sound of living things (including human voice) disappears into the air at the moment being made by vibration. Accordingly, people usually records sound in writing or in a recorder in order to use the sound.

Writing represents a predetermined sound pattern as a symbol according to the defined promise, but in a strict sense, it cannot be said to represent the sound itself.

The recorder can store and reproduce sound, but it does not allow people to view the recorded sound itself.

Sound viewing is to view sound waves caused by the vibration of the object. Sound viewing has been recently realized with development of computing technology for converting sound into digital information.

In particular, in the acoustic industries, technology for storing sound as digital information and editing the digital information is used to produce advertising music, film music, and the like. In producing such music, sound is stored in the format of wave file and is expressed two-dimensionally on a computer monitor.

Meanwhile, sound has not been manufactured as an article yet. That is, there is no case in which the sound wave of a word or a sentence spoken by someone is accurately manufactured as an article, and other people touch and view the article and feel realism through the article.

The applicant applied for a patent on technology for manufacturing sound of living things (including human voice) as three-dimensional articles in the Korean Intellectual Property Office on September 28, and was granted a patent on Nov. 22, 2007 (see Korean Patent Registration No. 10-0780467).

Korean Patent Registration No. 10-0780467 discloses a technology that converts sound of living things into three-dimensional images and manufactures three-dimensional articles based on the three-dimensional images. This is an early-stage technology in which the sound of living things is manufactured as three-dimensional articles without any change. The three-dimensional articles manufactured in this way have the shape of sound itself, and thus they are manufactured in a complex shape (usually, a shape having multiple spines of different lengths), as shown in FIG. 1.

That is, Korean Patent Registration No. 10-0780467 discloses the technology that enables the sound of living things to be reflected as it is. In this case, however, it is impossible to highlight a characteristic portion of sound and to modify the sound in various ways.

### DISCLOSURE

### Technical Problem

The invention has been suggested in consideration of the drawbacks inherent in the related art. It is an object of the invention to provide an apparatus and method of manufacturing an article using sound which is capable of modifying sound waveforms of sound of living things (including human voice) in various shapes and manufacturing articles corresponding to the shapes.

### Technical Solution

According to an aspect of the invention, an apparatus for manufacturing an article using sound includes: a sound waveform generation unit that generates a sound waveform from input sound; a sampling waveform generation unit that samples the sound waveform from the sound waveform generation unit and generates a sampling waveform; a two-dimensional image conversion unit that converts the sampling waveform from the sampling waveform generation unit into a two-dimensional image file; and a two-dimensional article manufacturing unit that manufactures a two-dimensional article based on the two-dimensional image file from the two-dimensional image conversion unit.

The apparatus may further include a display unit that displays on a screen at least one of the sound waveform from the sound waveform generation unit, the sampling waveform from the sampling waveform generation unit, and the two-dimensional image file from the two-dimensional image conversion unit.

The apparatus may further include a storage unit that stores at least one of the sound waveform, the sampling waveform, and the two-dimensional image file.

The apparatus may further include a key input unit that inputs a signal for selecting information to be stored in the storage unit.

The apparatus may further include a color conversion unit that converts the color of at least one of the sound waveform, the sampling waveform, and the two-dimensional image file.

According to another aspect of the invention, an apparatus for manufacturing an article using sound includes: a sound waveform generation unit that generates a sound waveform from input sound; a sampling waveform generation unit that samples the sound waveform from the sound waveform generation unit and generates a sampling waveform; a two-dimensional image conversion unit that converts the sampling waveform from the sampling waveform generation unit into a two-dimensional image file; a two-dimensional article manufacturing unit that manufactures a two-dimensional article based on the two-dimensional image file from the two-dimensional image conversion unit; a three-dimensional image conversion unit that converts the two-dimensional image file from the two-dimensional image conversion unit into a three-dimensional image file; and a three-dimensional article manufacturing unit that manufactures a three-dimensional article based on the three-dimensional image file from the three-dimensional image conversion unit.

The apparatus may further include a display unit that displays on a screen at least one of the sound waveform from the sound waveform generation unit, the sampling waveform from the sampling waveform generation unit, the two-dimensional image file from the two-dimensional image conversion unit, and the three-dimensional image file from the three-dimensional image conversion unit.

The apparatus may further include a storage unit that stores at least one of the sound waveform, the sampling waveform, the two-dimensional image file, and the three-dimensional image file.

The apparatus may further include a key input unit that inputs a signal for selecting information to be stored in the storage unit.

The apparatus may further include a color conversion unit that converts the color of at least one of the sound waveform, the sampling waveform, the two-dimensional image file, and the three-dimensional image file.

The two-dimensional image conversion unit may convert the sampling waveform into the two-dimensional image file by matching a figure image to the end of the sampling waveform from the sampling waveform generation unit.

The two-dimensional article manufacturing unit may directly print a two-dimensional image on the surface of an object.

The two-dimensional article manufacturing unit outputs a two-dimensional image in the form of a transfer paper or a sticker.

The apparatus may further include a sound collection unit that collects sound and inputs the collected sound to the sound waveform generation unit.

According to yet another aspect of the invention, there is provided a method of manufacturing an article using sound, the method including the steps of: (1) causing a sound waveform generation unit to generate a sound waveform from input sound; (2) causing a sampling waveform generation unit to sample the sound waveform and generate a sampling waveform; (3) causing a two-dimensional image conversion unit to convert the sampling waveform into a two-dimensional image file; and (4) causing a two-dimensional article manufacturing unit to manufacture a two-dimensional article based on the two-dimensional image file.

The method may further include a step of: (5) causing a display unit to display on a screen at least one of the sound waveform, the sampling waveform, and the two-dimensional image file.

The method may further include a step of: causing a storage unit to store at least one of the sound waveform, the sampling waveform, and the two-dimensional image file.

The method may further include a step of: causing a color conversion unit to convert the color of at least one of the sound waveform, the sampling waveform, and the two-dimensional image file.

According to yet another aspect of the invention, there is provided a method of manufacturing an article using sound, the method including the steps of: (1) causing a sound waveform generation unit to generate a sound waveform from input sound; (2) causing a sampling waveform generation unit to sample the sound waveform and generate a sampling waveform; (3) causing a two-dimensional image conversion unit to convert the sampling waveform into a two-dimensional image file; (4) causing a two-dimensional article manufacturing unit to manufacture a two-dimensional article based on the two-dimensional image file; (5) causing a three-dimensional image conversion unit to convert the two-dimensional image file into a three-dimensional image file; and (6) causing a three-dimensional article manufacturing unit to manufacture a three-dimensional article based on the three-dimensional image file.

The method may further include a step of: (7) causing a display unit to display on a screen at least one of the sound waveform, the sampling waveform, the two-dimensional image file, and the three-dimensional image file.

The method may further include a step of: causing a storage unit to store at least one of the sound waveform, the sampling waveform, the two-dimensional image file, and the three-dimensional image file.

The method may further include a step of: causing a color conversion unit to convert the color of at least one of the sound waveform, the sampling waveform, the two-dimensional image file, and the three-dimensional image file.

In the step (3), the two-dimensional image conversion unit may convert the sampling waveform into the two-dimensional image file by matching a figure image to the end of the sampling waveform from the sampling waveform generation unit.

In the step (4), the two-dimensional article manufacturing unit may directly print a two-dimensional image on the surface of an object.

In the step (4), the two-dimensional article manufacturing unit outputs a two-dimensional image in the form of a transfer paper or a sticker.

### ADVANTAGEOUS EFFECTS

According to the aspects of the invention, the apparatus and method of manufacturing an article using sound manufactures an article based on a sampling waveform generated by sampling a sound waveform, thereby manufacturing a simplified article.

Furthermore, the apparatus and method of manufacturing an article using sound converts a sampling waveform into a two-dimensional image file by matching a figure image, thereby manufacturing articles in various shapes.

### DESCRIPTION OF DRAWINGS

FIG. 1 is a diagram illustrating a three-dimensional article which is manufactured by an apparatus for manufacturing an article using sound according to the related art.

FIG. 2 is a diagram illustrating the structure of an apparatus for manufacturing an article using sound according to an embodiment of the invention.

FIG. 3 is a diagram illustrating an example of an output from a sound waveform generation unit shown in FIG. 1 displayed on a screen.

FIG. 4 is a diagram illustrating an example of an output from a sampling waveform generation unit shown in FIG. 1 displayed on a screen.

FIG. 5 is a diagram illustrating an example of an output from a two-dimensional image conversion unit shown in FIG. 1 displayed on a screen.

FIG. 6 is a diagram illustrating an example of a two-dimensional article which is manufactured according to an embodiment of the invention.

FIG. 7 is a diagram illustrating an example of an output from a three-dimensional image conversion unit shown in FIG. 1 displayed on a screen.

FIG. 8 is a diagram illustrating an example of a three-dimensional article which is manufactured according to an embodiment of the invention.

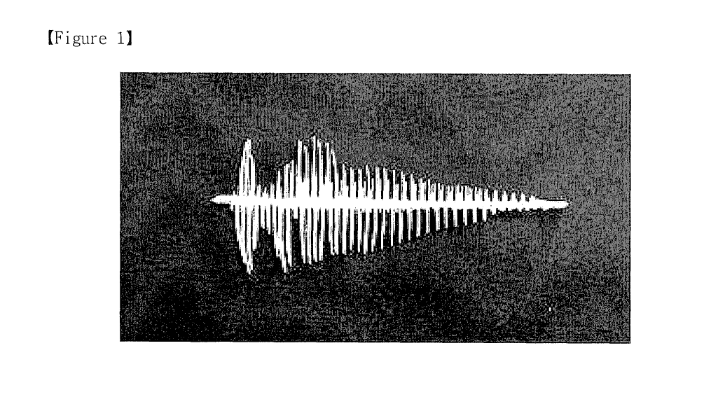

### DESCRIPTION OF REFERENCE NUMERALS AND SIGNS

10: SOUND COLLECTION UNIT
15: SOUND WAVEFORM GENERATION UNIT
20: SAMPLING WAVEFORM GENERATION UNIT
25: TWO-DIMENSIONAL IMAGE CONVERSION UNIT
30: TWO-DIMENSIONAL ARTICLE MANUFACTURING UNIT
35: THREE-DIMENSIONAL IMAGE CONVERSION UNIT
40: THREE-DIMENSIONAL ARTICLE MANUFACTURING UNIT
45: FIRST STORAGE UNIT
50: SECOND STORAGE UNIT
55: THIRD STORAGE UNIT
60: FOURTH STORAGE UNIT
65: STORAGE UNIT
70: KEY INPUT UNIT
75: DISPLAY UNIT
80: CONTROL UNIT

### BEST MODE

In the following detailed description, an exemplary embodiment of the invention have been shown and described, simply by way of illustration. As those skilled in the art would realize, the described embodiment may be modified in various different ways, all without departing from the spirit or scope of the invention. It should be noted that the same components are represented by the same reference numerals even if they are shown in different drawings. In addition, in the following description, detailed description of known structures and functions incorporated herein will be omitted when it may make the subject matter of the invention unclear.

An apparatus and method of manufacturing an article using sound will now be described with reference to the accompanying drawings.

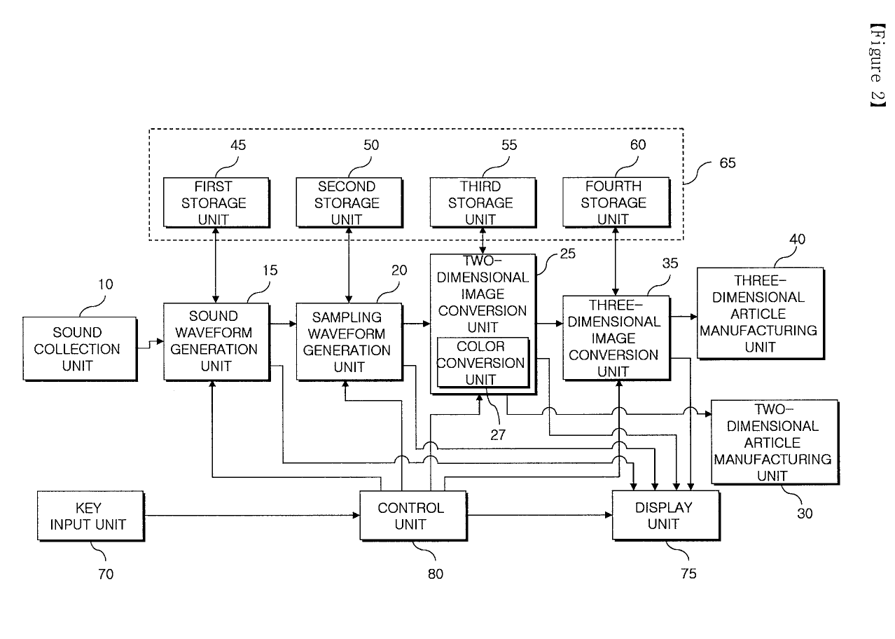

FIG. 2 is a diagram illustrating the structure of an apparatus for manufacturing an article using sound according to an embodiment of the invention. The apparatus for manufacturing an article using sound includes a sound collection unit 10, a sound waveform generation unit 15, a sampling waveform generation unit 20, a two-dimensional image conversion unit 25 including a color conversion unit 27, a two-dimensional article manufacturing unit 30, a three-dimensional image conversion unit 35, a three-dimensional article manufacturing unit 40, a storage unit 65 including a first storage unit 45, a second storage unit 50, a third storage unit 55, and a fourth storage unit 60, a key input unit 70, a display unit 75, and a control unit 80.

The sound collection unit 10 collects sound of an animal or a word or a sentence spoken by a speaker. The sound collection unit 10 is preferably constituted from a microphone. In addition, the sound collection unit 10 may be constituted from a digital recorder that can record (or store) sound of an animal or a word or a sentence spoken by a speaker. Here, when the sound collection unit 10 is constituted from a digital recorder, a first storage unit 45 described below is not provided.

The sound waveform generation unit 15 generates a digital sound waveform (for example, in a wave (wav) file format) based on sound input from the sound collection unit 10. Here, the wave file is a sound file generated by digitalizing analog audio and can be edited, if necessary. The sound waveform generation unit 15 includes a noise reduction circuit (not shown) that reduces a noise component in the sound from the sound collection unit 10. In addition, if necessary, the sound waveform generation unit 15 may include an amplifier that amplifies the sound from the sound collection unit 10.

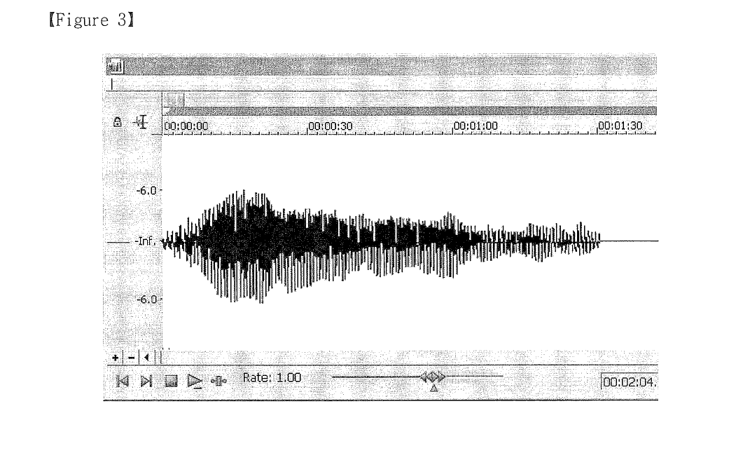

The sound waveform generation unit 15 displays the generated digital sound waveform (for example, in a wave (wav) file format) on the display unit 75 by using a program (internally stored program), such as Wavelab or Sound Forge. The sound waveform to be displayed on the display unit 75 is as illustrated in FIG. 3.

The sampling waveform generation unit 20 samples the digital sound waveform (that is, the sound waveform of the wave (wav) file format) from the sound waveform generation unit 15 and generates a sampling waveform. Here, the digital sound waveform is a waveform having information about sound. Since the digital sound waveform has a complex form defined according to sound, as a preprocessing for simplifying the digital sound waveform and manufacturing various shapes of articles, the sampling waveform is generated. That is, the sampling waveform generation unit 20 generates the sampling waveform by dividing the digital sound waveform into multiple sections, calculating the average of waveforms in each section, and setting the average as the waveform of the corresponding section.

In addition, the sampling waveform generation unit 20 may generate the sampling waveform by dividing the digital sound waveform into multiple sections, the peak-to-peak value of waveforms in each section, and setting the peak-to-peak value as the waveform of the corresponding section. Here, the peak-to-peak value is an interval between the maximum value and the minimum value in each section. For example, when the maximum value of a section is “8” and the minimum value of the section is “−3”, the sampling waveform generation unit 20 sets the interval “11” between the maximum value and the minimum value as the peak-to-peak value.

Alternatively, the sampling waveform generation unit 20 may generate the sampling waveform by dividing the digital sound waveform into multiple sections, selecting a waveform from among waveforms in each section at a predetermined position (for example, first waveform, second waveform, maximum waveform, or minimum waveform).

The sampling waveform generation unit 20 may generate the sampling waveform by a known sampling method, in addition to the above-described methods.

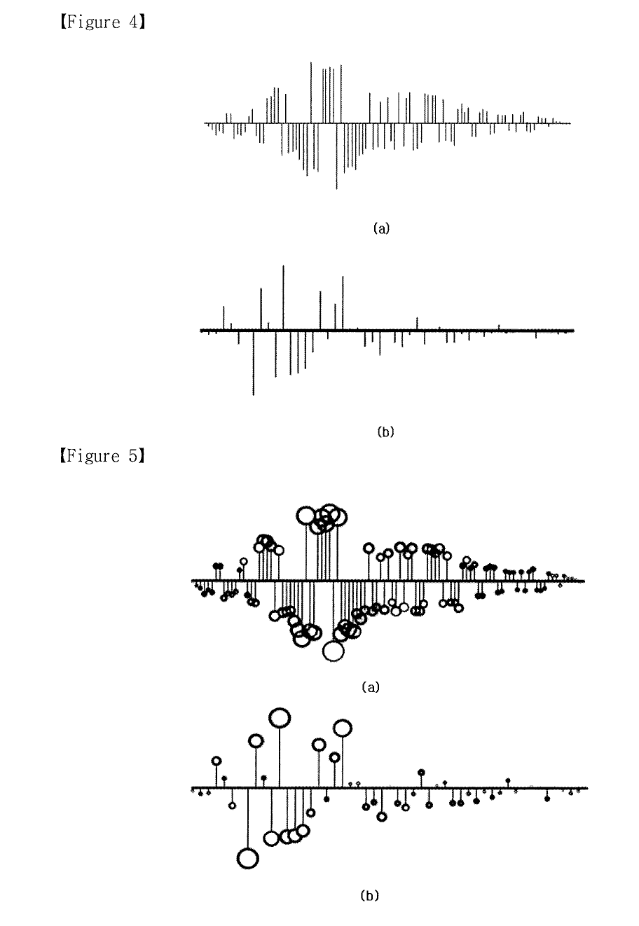

The sampling waveform generation unit 20 has a program for sampling the digital sound waveform. The sampling waveform to be displayed on the display unit 75 is as illustrated in FIG. 4. In FIG. 4, (a) is a sampling waveform which is generated by dividing the sound waveform shown in FIG. 3 into 100 sections, and (b) is a sampling waveform which is generated by dividing the sound waveform shown in FIG. 3 into 50 sections.

The two-dimensional image conversion unit 25 converts the sampling waveform from the sampling waveform generation unit 20 into a two-dimensional image file (for example, an image film format, such as JPG, JPEG, BMP, GIF, or TIF). The sampling waveform is generated by sampling the digital sound waveform, but three-dimensional reconstruction cannot be achieved directly from the sampling waveform. Accordingly, as a preprocessing for the three-dimensional reconstruction, the two-dimensional image file is generated.

The two-dimensional image conversion unit 25 includes a color conversion unit 27 that converts the color of the sampling waveform from the sampling waveform generation unit 20. The color conversion unit 27 converts the color of the sampling waveform, which is usually black, into various colors (for example, red, orange, yellow, yellowish green, green, bluish green, blue, dark blue, violet, purple, pink, and brown). That is, the color conversion unit 27 converts the color of the sampling waveform displayed on the display unit 75 based on a key input signal of an operator (for example, a color selection signal). In this embodiment, the color conversion unit 27 is incorporated into the two-dimensional image conversion unit 25, but if necessary, the color conversion unit 27 may be incorporated into one of the sound waveform generation unit 15, the sampling waveform generation unit 20, and the three-dimensional image conversion unit 35. In addition, the color conversion unit 27 may be provided separately from the sound waveform generation unit 15, the sampling waveform generation unit 20, the two-dimensional image conversion unit 25, and the three-dimensional image conversion unit 35. For example, when the color conversion unit 27 is provided between the sound waveform generation unit 15 and the sampling waveform generation unit 20, the color conversion unit 27 converts the color of the sound waveform from the sound waveform generation unit 15 and transmits the color-converted sound waveform to the sampling waveform generation unit 20. When the color conversion unit 27 is provided between the sampling waveform generation unit 20 and the two-dimensional image conversion unit 25, the color conversion unit 27 converts the color of the sampling waveform from the sampling waveform generation unit 20 and transmits the color-converted sampling waveform to the two-dimensional image conversion unit 25. When the color conversion unit 27 is provided between the two-dimensional image conversion unit 25 and the two-dimensional article manufacturing unit 30, the color conversion unit 27 converts the color of the two-dimensional image from the two-dimensional image conversion unit 25 and transmits the color-converted two-dimensional image to the two-dimensional article manufacturing unit 30. When the color conversion unit 27 is provided between the two-dimensional image conversion unit 25 and the three-dimensional image conversion unit 35, the color conversion unit 27 converts the color of the two-dimensional image from the two-dimensional image conversion unit 25 and transmits the color-converted two-dimensional image to the three-dimensional image conversion unit 35. When the color conversion unit 27 is provided between the three-dimensional image conversion unit 35 and the three-dimensional article manufacturing unit 40, the color conversion unit 27 converts the color of the three-dimensional image from the three-dimensional image conversion unit 35 and transmits the color-converted three-dimensional image to the three-dimensional article manufacturing unit 40.

In particular, the two-dimensional image conversion unit 25 may converts the sampling waveform into various forms of two-dimensional images by matching an image of a figure (for example, circle, heart, diamond, or star) to the end of the sampling waveform from the sampling waveform generation unit. Here, the term “matching” means the sampling waveform is arranged such that the end point of the sampling waveform overlaps a point of the figure.

The two-dimensional image from the two-dimensional image conversion unit 25 is displayed on the display unit 75. The two-dimensional image to be displayed on the display unit 75 is as illustrated in FIG. 5. In FIG. 5, (a) is a two-dimensional image which is converted by matching a circle to the end of the sampling waveform shown in (a) of FIG. 4, and (b) is a two-dimensional image which is converted by matching a circle to the end of the sampling waveform shown in (b) of FIG. 4. In addition to the two-dimensional images shown in (a) and (b) of FIG. 5, a two-dimensional image to be displayed on the display unit 75 may be changed in various ways according to the sampling result in the sampling waveform generation unit 20 and the image of the figure to be matched (for example, circle, heart, diamond, or star) in the two-dimensional image conversion unit 25.

The two-dimensional article manufacturing unit 30 manufactures a two-dimensional article based on the output result of the two-dimensional image conversion unit 25 (that is, two-dimensional image). The two-dimensional article manufacturing unit 30 is constituted from an output device (for example, a printer, a screen printer, a rubber printer, or a transfer printer), which can print an image on various objects.

The two-dimensional article manufacturing unit 30 directly prints the two-dimensional image from the two-dimensional image conversion unit 25 on the surface of an object, or outputs the two-dimensional image in the form of a transfer paper or a sticker. That is, the two-dimensional article manufacturing unit 30 directly prints the two-dimensional image on the surface of an object, such as cloth, kitchen utensils, accessory, stationery, sporting goods, appliance, furniture, hobby goods, tablet, book, or bag. The two-dimensional article manufacturing unit 30 may output the two-dimensional image in the form of a transfer paper (or sticker). Since the two-dimensional image is output in the form of a transfer paper or a sticker, it is possible for a user to attach later the transfer paper or the sticker on the surface of the object, such as cloth, kitchen utensils, accessory, stationery, sporting goods, appliance, furniture, hobby goods, tablet, book, or bag.

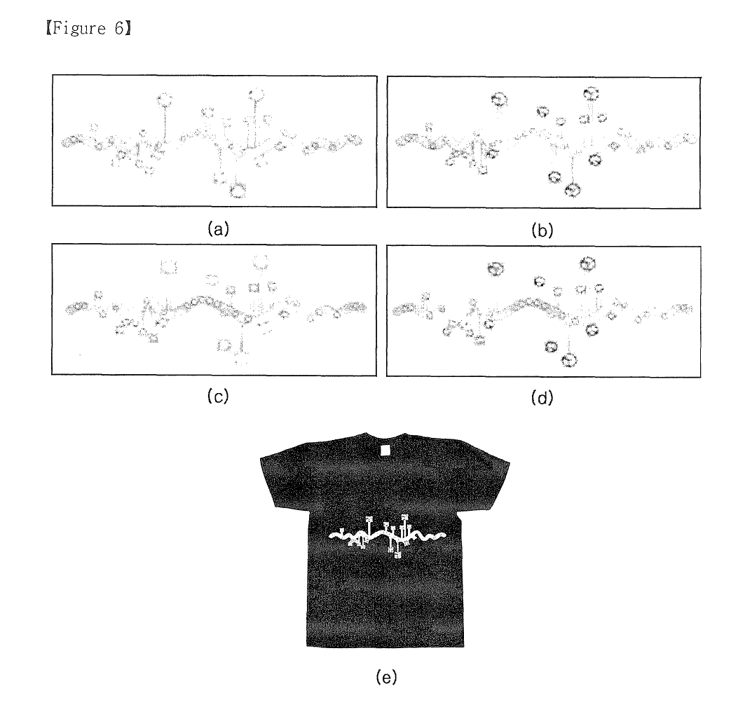

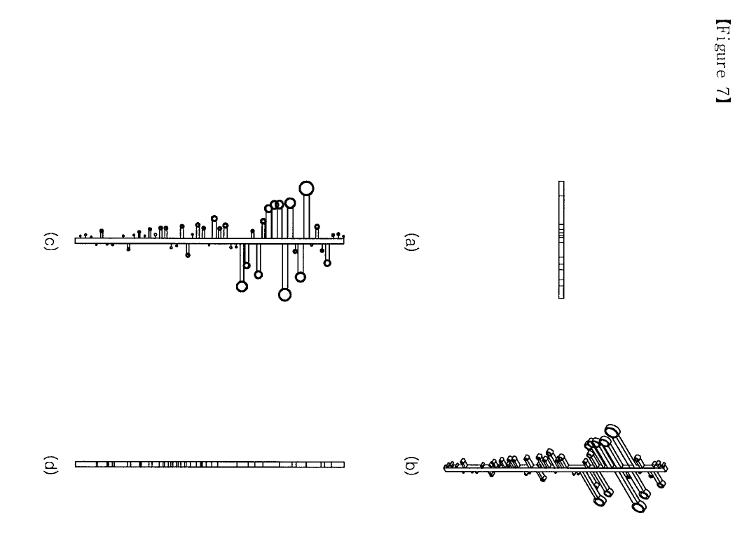

The two-dimensional article which is manufactured by the two-dimensional article manufacturing unit 30 is as illustrated in FIG. 6. In FIG. 6, (a) is a two-dimensional article which is output in the form of a monochrome sticker from the output device, and (b) is a two-dimensional article which is output in the form of a sticker with coloring a figure image. In addition, (c) is a two-dimensional article which is output in the form of a sticker with coloring a waveform image, (d) is a two-dimensional article which is output in the form of a sticker with coloring a waveform image and a figure image. Furthermore, (e) is a two-dimensional article which is printed directly on a tee shirt. The two-dimensional article manufacturing unit 30 may directly print other two-dimensional images than the two-dimensional images shown in FIG. 6 on various objects, or print them in the forms of transfer papers or stickers, thereby manufacturing various shapes of two-dimensional articles.

The three-dimensional image conversion unit 35 converts the two-dimensional image file from the two-dimensional image conversion unit 25 into a three-dimensional image file. The three-dimensional image conversion unit 35 includes a program (for example, Jewel CAD or 3D CAD) for automatically designing a three-dimensional object. The three-dimensional image conversion unit 35 may create the three-dimensional image by simply adding the thickness (or height) to the two-dimensional image, or may create an asymmetric conical or cylindrical three-dimensional image by rotating the two-dimensional image around the X axis at 180 degrees. In addition, the three-dimensional image conversion unit 35 may create a hollow cylindrical three-dimensional image by moving upward the value of a positive (+) region on the Y axis of the two-dimensional image with respect to the X axis in parallel by a predetermined value, and moving downward the value of a negative (−) region on the Y axis with respect to the X axis in parallel by a predetermined value, and rotating the obtained image at 180 degrees. The three-dimensional image file created by the three-dimensional image conversion unit 35 is created in various ways as desired. The three-dimensional image output from the three-dimensional image conversion unit 35 is displayed on the display unit 75, as illustrated in FIG. 7. In FIG. 7 illustrates an image which is crated by adding the thickness (or height) to the sampling waveform shown in (b) of FIG. 5, rotating the obtained image at 90 degrees, and placing the image in a vertical direction. In FIG. 7, (a) is an image when the sampling waveform shown in (b) of FIG. 5 is viewed from above, and (b) is an image when the sampling waveform shown in (b) of FIG. 5 is viewed in perspective (three-dimensionally). In addition, (c) is an image when the sampling waveform shown in (b) of FIG. 5 is viewed from front (that is, a front view when the sampling waveform stands erect), and (d) is an image when the sampling waveform shown in (b) of FIG. 5 is viewed from the right side. Though not shown, a printer that outputs the three-dimensional image created by the three-dimensional image conversion unit 35 may be provided.

The three-dimensional article manufacturing unit 40 manufactures a three-dimensional article based on the output result of the three-dimensional image conversion unit 35 (that is, three-dimensional image). The three-dimensional article manufacturing unit 40 includes a molder (not shown) which forms various shapes of molds, casts, press molds, and wax models. The three-dimensional article manufacturing unit 40 forms a mold suitable for the three-dimensional image output from the three-dimensional image conversion unit 35, and then manufactures the three-dimensional article with the mold.

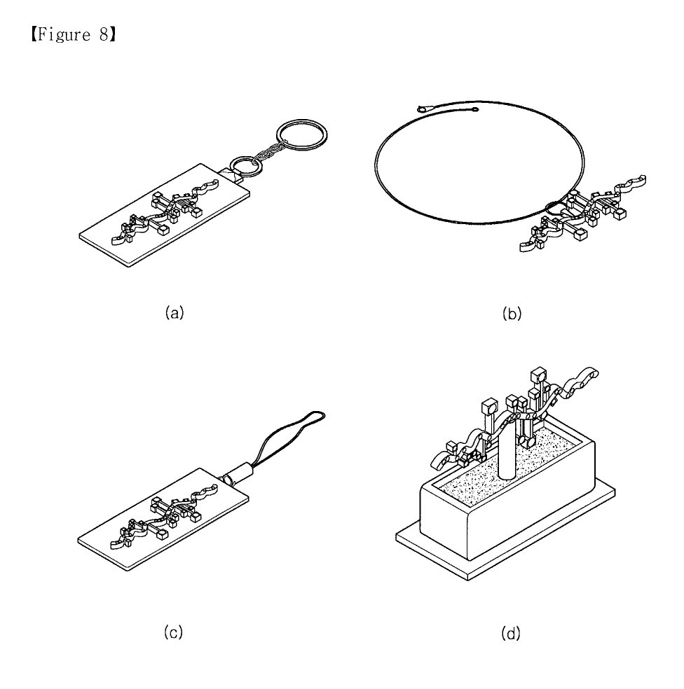

The three-dimensional article manufactured by the three-dimensional article manufacturing unit 40 can be used to design various shapes of articles. For example, the three-dimensional article can be used to design a key ring shown in (a) of FIG. 8 or an accessory shown in (b) of FIG. 8. In addition, the three-dimensional article can be used to design a mobile phone accessory shown in (c) of FIG. 8 or a sculpture shown in (d) of FIG. 8.

The storage unit 65 includes a first storage unit 45 that stores the sound waveform output from the sound waveform generation unit 15, a second storage unit 50 that stores the sampling waveform output from the sampling waveform generation unit 20, a third storage unit 55 that stores the two-dimensional image file output from the two-dimensional image conversion unit 25, and a fourth storage unit 60 that stores the three-dimensional image file output from the three-dimensional image conversion unit 35. In FIG. 2, the first storage unit 45, the second storage unit 50, the third storage unit 55, and the fourth storage unit 60 are provided separately in the storage unit 65, but they may be constituted from a single storage unit.

The key input unit 70 has multiple keys and is used to input a required operation command. For example, the key input unit 70 is used to input a command to delete or store the sound waveform displayed on the display unit 75, a command to delete or store the sampling waveform displayed on the display unit 75, a command to delete or store the two-dimensional image displayed on the display unit 75, and a command to delete or store the three-dimensional image displayed on the display unit 75. In addition, the key input unit 70 may be used to input a key operation signal for modifying the two-dimensional image generated by the two-dimensional image conversion unit 25 or the three-dimensional image generated by the three-dimensional image conversion unit 35 into a desired shape.

In particular, the sound waveform varies according to the environment in which a word is spoken, and thus according to the key input through the key input unit 70, one sound waveform may be selected from among different sound waveforms (that is, different sound waveforms of the same word). That is, when a speaker speaks at a quiet place and at a noisy place, different waveforms are obtained according to the degree of noise mixing. In addition, when the speaker speaks in the morning and in the afternoon, or when the speaker speaks at a cold place and at a warm place, different waveforms may be obtained.

Furthermore, the key input unit 70 may be used to input a numeric value for dividing the sound waveform so as to generate the sampling waveform. For example, when a numeric value “100” is input through the key input unit 70, the sampling waveform generation unit 20 divides the sound waveform into 100 sections and generates the sampling waveform of each section.

The display unit 75 is constituted from a unit, such as a computer monitor, which displays on a screen the sound waveform, the sampling waveform, the two-dimensional image, and the three-dimensional image.

The control unit 80 controls the entire operation of the apparatus according to the embodiment of the invention.

The operation of the apparatus for manufacturing an article using sound according to the embodiment of the invention will now be described. In the following description, an operation until the apparatus manufactures an article using a word spoken by a speaker will be described.

If a speaker speaks a word, for example, “dream”, toward the sound collection unit 10, the sound collection unit 10 collects sound of the word “dream” and transmits the collected sound to the sound waveform generation unit 15.

The sound waveform generation unit 15 generates a digital sound waveform (for example, in a wave (way) file format) from the input sound by using a program, such as Wavelab or Sound Forge, and displays the generated digital sound waveform on the display unit 75. Here, the sound waveform shown in FIG. 3 is displayed on the display unit 75. Of course, the speaker may input sound by speaking the characters of the word “dream” with different times, and thus multiple sound waveforms of the same word may be displayed on the display unit 75.

If a selection signal is input to the control unit 80 through the key input unit 70 with respect to the sound waveforms displayed on the display unit 75, the control unit 80 controls the sound waveform generation unit 15 to store the selected sound waveform in the first storage unit 45. The sound waveform may not be stored in the first storage unit 45. Meanwhile, if the sound waveform is stored in the first storage unit 45, various shapes of sampling waveforms can be generated by using the stored sound waveform without performing sound collection and sound waveform generation again. Accordingly, it is preferable to store the sound waveform in the first storage unit 45.

Next, the control unit 80 controls the sampling waveform generation unit 20 to generate a sampling waveform based on the selected sound waveform, to display the generated sampling waveform on the display unit 75, and to store the generated sampling waveform in the second storage unit 50. The sampling waveform generation unit 20 displays the generated sampling waveform on the display unit 75, as shown in FIG. 4, and stores the generated sampling waveform in the second storage unit 50.

The sampling waveform may not be stored in the second storage unit 50. Meanwhile, if the sampling waveform is stored in the second storage unit 50, the same image as the previously created two-dimensional image can be created by using the stored sampling waveform without performing sound collection, sound waveform generation, and sampling waveform generation. Accordingly, it is preferable to store the sampling waveform in the second storage unit 50. As such, the apparatus and method of manufacturing an article using sound manufactures an article based on the sampling waveform generated by sampling the sound waveform, thereby manufacturing a simplified article.

Thereafter, the control unit 80 controls the two-dimensional image conversion unit 25 to convert the sampling waveform into a two-dimensional image. That is, in view of ease of image extraction for three-dimensional reconstruction, the two-dimensional image conversion unit 25 receives the sampling waveform from the sampling waveform generation unit 20 and converts the sampling waveform into the two-dimensional image file (for example, JPG, JPEG, BMP, GIF, or TIF file). Here, the two-dimensional image conversion unit 25 may convert the sampling waveform into the two-dimensional image file by matching an image of a figure (for example, circle, heart, diamond, or star) to the end of the sampling waveform. The term “matching” means the sampling waveform is arranged such that the end point of the sampling waveform overlaps a point of the figure. In addition, the two-dimensional image conversion unit 25 may convert the color of the sampling waveform from the sampling waveform generation unit 20 by means of the color conversion unit 27.

Of course, the conversion result (two-dimensional image) in the two-dimensional image conversion unit 25 is displayed on the display unit 75, as shown in FIG. 5. And, the two-dimensional image displayed on the display unit 75 is stored in the third storage unit 55. In this way, if the two-dimensional image is stored in the third storage unit 55, the same article as the previously manufactured two-dimensional article can be manufactured by using the stored two-dimensional image without performing image conversion again. As such, the apparatus and method of manufacturing an article using sound converts the sampling waveform into the two-dimensional image file by matching the figure image to the sampling waveform, thereby manufacturing various shapes of articles.

Next, the two-dimensional image conversion unit 25 transmits the two-dimensional image file to the two-dimensional article manufacturing unit 30. Then, the two-dimensional article manufacturing unit 30 manufactures a two-dimensional article corresponding to the two-dimensional image. That is, the two-dimensional article manufacturing unit 30 directly prints the two-dimensional image from the two-dimensional image conversion unit 25 on the surfaces of various objects. The two-dimensional article manufacturing unit 30 may print the two-dimensional image in the form of a transfer paper or a sticker. The two-dimensional article manufactured by the two-dimensional article manufacturing unit 30 is as shown in FIG. 6. That is, the two-dimensional article shown in FIG. 6 is an example of a two-dimensional article manufactured when a person speaks the word “dream”. The two-dimensional article may be colored.

Next, the two-dimensional image conversion unit 25 transmits the two-dimensional image file to the three-dimensional image conversion unit 35. Then, the three-dimensional image conversion unit 35 converts the two-dimensional image file into a three-dimensional image by using an internal program. That is, the three-dimensional image conversion unit 35 converts the two-dimensional image into the three-dimensional image by a conversion method defined in the program according to the key input of the operator. The image converted by the three-dimensional image conversion unit 35 is displayed on the display unit 75. The three-dimensional image to be displayed on the display unit 75 is as shown in FIG. 7.

Next, if conversion is completed, the three-dimensional image conversion unit 35 stores the three-dimensional image in the fourth storage unit 60. In this way, if the three-dimensional image is stored in the fourth storage unit 60, the same article as the previously manufactured three-dimensional article can be manufactured by using the stored three-dimensional image, without performing image conversion again.

Finally, the three-dimensional article manufacturing unit 40 manufactures a three-dimensional article. That is, the three-dimensional article manufacturing unit 40 forms a mold having a shape or a pattern suitable for the three-dimensional image from the three-dimensional image conversion unit 35, putting in the mold materials, such as gold, silver, jade, and bioceramics, alone or in combination, and solidifying the materials, thereby manufacturing a desired three-dimensional article. The three-dimensional article manufactured by the three-dimensional article manufacturing unit 40 is as shown in FIG. 8. That is, the three-dimensional article shown in FIG. 8 is an example of a three-dimensional article finally manufactured when a person speaks the word “dream”. In FIG. 8, (a) shows a key ring which is designed based on the three-dimensional article, and (b) shows an accessory which is designed based on the three-dimensional article. In addition, (c) shows a mobile phone accessory which is designed based on the three-dimensional article, and (d) shows a sculpture which is designed based on the three-dimensional article.

The three-dimensional article manufacturing unit 40 may color the three-dimensional article. When the materials, such as gold, silver, jade, and bioceramics, are put in the mold, if a material for a desired color is put together, the three-dimensional article has a desired color.

In manufacturing an article, the two-dimensional article may be manufactured by using the two-dimensional image stored in the third storage unit 55, without performing sound collection. In addition, the mold formed by the three-dimensional article manufacturing unit 40 may be preserved without being fell into disuse. Accordingly, when a three-dimensional article for the corresponding word is manufactured, the three-dimensional article can be manufactured by using the preserved mold.

In this embodiment, the sound waveform generation unit 15 generates the digital sound waveform in the wave (wav) file format from sound, but the invention is not limited thereto. For example, any file format, such as MP3, OGG, or WMA, may be used insofar as a sound waveform can be obtained.

In the above-description, a case in which both the two-dimensional article and the three-dimensional article are manufactured has been described, but one of the two-dimensional article and the three-dimensional article may be selectively manufactured.

It should be understood that the invention is not limited to the above-described embodiment, but various modifications and changes can be made without departing from the subject matter of the invention. In addition, all modifications and changes that fall within metes and bounds of the claims, or equivalents of such metes and bounds are intended to be embraced by the claims.

1. An apparatus for manufacturing an article using sound, the apparatus comprising:
a sound waveform generation unit that generates a sound waveform from input sound;
a sampling waveform generation unit that samples the sound waveform from the sound waveform generation unit and generates a sampling waveform;
a two-dimensional image conversion unit that converts the sampling waveform from the sampling waveform generation unit into a two-dimensional image file; and
a two-dimensional article manufacturing unit that manufactures a two-dimensional article based on the two-dimensional image file from the two-dimensional image conversion unit.

2. The apparatus of claim 1, further comprising:
a display unit that displays on a screen at least one of the sound waveform from the sound waveform generation unit, the sampling waveform from the sampling waveform generation unit, and the two-dimensional image file from the two-dimensional image conversion unit.

3. The apparatus of claim 1, further comprising:
a storage unit that stores at least one of the sound waveform, the sampling waveform, and the two-dimensional image file.

4. The apparatus of claim 3, further comprising:
a key input unit that inputs a signal for selecting information to be stored in the storage unit.

5. The apparatus of claim 1, further comprising:
a color conversion unit that converts the color of at least one of the sound waveform, the sampling waveform, and the two-dimensional image file.

6. The apparatus of claim 1, wherein the two-dimensional image conversion unit converts the sampling waveform into the two-dimensional image file by matching a figure image to the end of the sampling waveform from the sampling waveform generation unit.

7. An apparatus for manufacturing an article using sound, the apparatus comprising:
a sound waveform generation unit that generates a sound waveform from input sound;
a sampling waveform generation unit that samples the sound waveform from the sound waveform generation unit and generates a sampling waveform;
a two-dimensional image conversion unit that converts the sampling waveform from the sampling waveform generation unit into a two-dimensional image file;
a two-dimensional article manufacturing unit that manufactures a two-dimensional article based on the two-dimensional image file from the two-dimensional image conversion unit;
a three-dimensional image conversion unit that converts the two-dimensional image file from the two-dimensional image conversion unit into a three-dimensional image file; and
a three-dimensional article manufacturing unit that manufactures a three-dimensional article based on the three-dimensional image file from the three-dimensional image conversion unit.

8. The apparatus of claim 7, further comprising:
a display unit that displays on a screen at least one of the sound waveform from the sound waveform generation unit, the sampling waveform from the sampling waveform generation unit, the two-dimensional image file from the two-dimensional image conversion unit, and the three-dimensional image file from the three-dimensional image conversion unit.

9. The apparatus of claim 7, further comprising:
a storage unit that stores at least one of the sound waveform, the sampling waveform, the two-dimensional image file, and the three-dimensional image file.

10. The apparatus of claim 9, further comprising:
a key input unit that inputs a signal for selecting information to be stored in the storage unit.

11. The apparatus of claim 7, further comprising:
a color conversion unit that converts the color of at least one of the sound waveform, the sampling waveform, the two-dimensional image file, and the three-dimensional image file.

12. A method of manufacturing an article using sound, the method comprising the steps of:
(1) causing a sound waveform generation unit to generate a sound waveform from input sound;
(2) causing a sampling waveform generation unit to sample the sound waveform and generate a sampling waveform;
(3) causing a two-dimensional image conversion unit to convert the sampling waveform into a two-dimensional image file; and
(4) causing a two-dimensional article manufacturing unit to manufacture a two-dimensional article based on the two-dimensional image file.

13. The method of claim 12, further comprising a step of:
(5) causing a display unit to display on a screen at least one of the sound waveform, the sampling waveform, and the two-dimensional image file.

14. The method of claim 12, further comprising a step of:
causing a storage unit to store at least one of the sound waveform, the sampling waveform, and the two-dimensional image file.

15. The method of claim 12, further comprising a step of:
causing a color conversion unit to convert the color of at least one of the sound waveform, the sampling waveform, and the two-dimensional image file.

16. A method of manufacturing an article using sound, the method comprising the steps of:
(1) causing a sound waveform generation unit to generate a sound waveform from input sound;
(2) causing a sampling waveform generation unit to sample the sound waveform and generate a sampling waveform;
(3) causing a two-dimensional image conversion unit to convert the sampling waveform into a two-dimensional image file;
(4) causing a two-dimensional article manufacturing unit to manufacture a two-dimensional article based on the two-dimensional image file;
(5) causing a three-dimensional image conversion unit to convert the two-dimensional image file into a three-dimensional image file; and
(6) causing a three-dimensional article manufacturing unit to manufacture a three-dimensional article based on the three-dimensional image file.

17. The method of claim 16, further comprising a step of:
(7) causing a display unit to display on a screen at least one of the sound waveform, the sampling waveform, the two-dimensional image file, and the three-dimensional image file.

18. The method of claim 16, further comprising a step of:
causing a storage unit to store at least one of the sound waveform, the sampling waveform, the two-dimensional image file, and the three-dimensional image file.

19. The method of claim 16, further comprising a step of:
causing a color conversion unit to convert the color of at least one of the sound waveform, the sampling waveform, the two-dimensional image file, and the three-dimensional image file.
